(19) United States
(12) Patent Application Publication
(10) Pub. No.: US 2004/0198385 A1
(43) Pub. Date: Oct. 7, 2004

(54) Mobile subscriber location service

(76) Inventors: Jill C. Wheeler, Gilbert, AZ (US); Bernard R. McKibben, Gilbert, AZ (US); Mary Maureen Madine, Tempe, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/317,880

(22) Filed: Dec. 12, 2002

(51) Int. Cl. H04M 3/42; H04Q 7/20

(52) U.S. Cl. 455/456.1; 455/414.1

(57) ABSTRACT

A mobile network (10) method provides location information of a mobile device (20) to a requester (30). The user of the mobile device pre-configures a location service profile to indicate authorized location service requesters, and activates or de-activates the service (61). When a request for location information of a mobile user is received, the network determines whether the request is an authorized one from the location service profile (65). If the request is authorized, the network retrieves the location information without placing a call simply by paging the mobile device (20) for the location information (69).

### BACKGROUND OF THE INVENTION

The present invention pertains to mobile communications and more particularly to a service for locating a mobile communication device subscriber.

Modern mobile telecommunications has moved from basic telephone service to a plethora of additional services. As the mobile phones and corresponding networks transition from first generation to 2.5 G and beyond, the mobile networks may provide additional features and services not included previously. These modern mobile telecommunication devices and networks provide wireless internet, wireless video services, etc.

Mobile telecommunications devices move along with their respective user. Cellular phones are commonly carried on belts or in purses and travel virtually everywhere the user does. Therefore, if the mobile telecommunication device is tracked, the person carrying the mobile telecommunication device may also be tracked.

It is advantageous for companies who provide repair services to know the location of their repair people who are in the field. Further it is advantageous for parents to know the location of their children or others inside large shopping malls, amusement parks or sporting arenas or stadiums.

Existing mobile telecommunication devices generally do not provide any non-interactive location based services for use by third parties.

Accordingly, it is highly desirable to provide a location service for third parties to track the mobile telecommunication device and corresponding user of that device, so that a third party may request an instantaneous location of the device and corresponding user without interacting with the user (i.e. not placing a phone call).

### BRIEF DESCRIPTION OF THE DRAWING

FIG. 1 is a block diagram of a network provided mobile device location service in accordance with the present invention.

FIG. 2 is a flow chart of a method for providing location based service of mobile telecommunication subscribers in accordance with the present invention.

### DESCRIPTION OF THE PREFERRED EMBODIMENT OF THE INVENTION

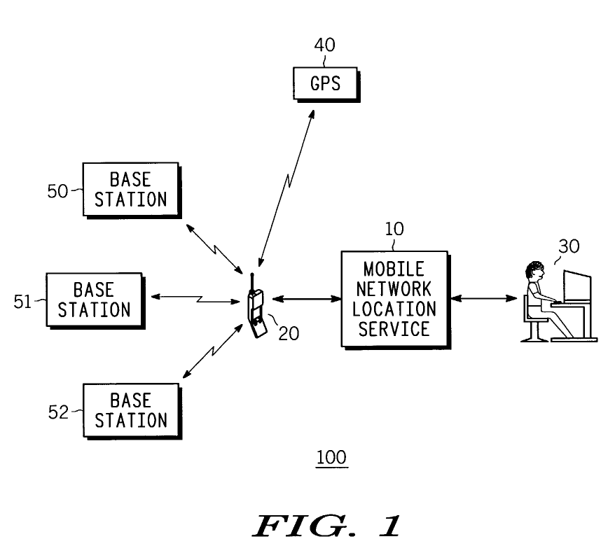

FIG. 1 is a block diagram of an arrangement for providing location services. An arrangement 100 for providing the location services is shown. Mobile network 10 provides the location services control and methodology. Mobile telecommunication device 20 is attached or carried by a subscriber or user (not shown). Third party 30 is also coupled to network 10 and requests the location of mobile telecommunication device 20 and correspondingly its user.

Network 10 must be a 2.5 G (generation) or greater wireless network. This invention can also be applied to 2 G networks as well, but in a restricted form of a custom application running on 2 G circuit data services. The requester 30 may include a personal computer or mobile telecommunication device 30, such as a 2.5 G or greater cellular phone with display.

GPS 40 is a Global Positioning System satellite or satellites that provide information for location determination by mobile telecommunication device 20.

Similarly, base stations 50-52 may be used to multilaterate for location determination by mobile telecommunication device 20, since base stations 50-52 are fixed at specific locations. Other multilateration or trianglulation systems may also be used.

The subscriber of device 20 pre-sets in the network 10 a location service profile or list of third parties to whom he gives permission to receive location information of device 20. This provides privacy for the subscriber of device 20 since he controls who has permission to seek the location services for the mobile device 20. The subscriber's device 20 may generate location service profile that is stored in mobile network 10. The location service profile may also be generated off-line by personal computer, for example. The location service profile is a list of individuals that have permission to receive the subscriber's location information. Only the subscriber of device 20 can configure this permission list. However, the list may be modified at any time.

Mobile device 20 may embody a cellular phone that is 2.5 G or greater in capabilities. The present location service allows individuals real time access to locate the user who carries device 20 without disturbing the user, such as by placing a phone call to the user. Such location service might allow the location of children, objects such as cargo or household pets. The subscriber of device 20 can be located without disruption to normal activities. For example, an administrator may locate an executive in a business meeting -without disruption to the meeting. Furthermore a family in a park or mall or sports stadium may keep track of their children, even if the children are currently engaged in an activity such as an amusement park ride. In addition, a visually or mentally challenged person may have a device that provides family members with this location information.

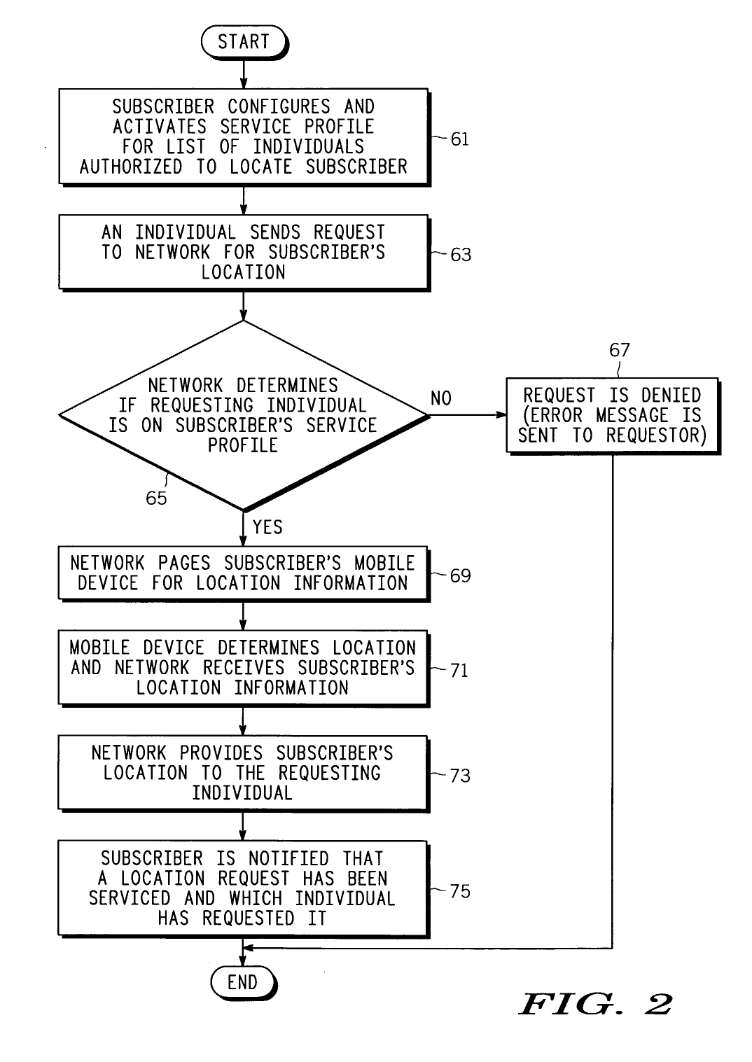

Referring to FIG. 2, a flow chart of the location service methodology is shown. As a precondition, the subscriber of device 20 configures and activates his service profile in network 10 for a list of individuals authorized to request location information of the subscriber, block 61. The list of individuals authorized to request location services can be the subscriber herself/himself such that the subscriber can find a lost wireless device through a fixed network access to the public land mobile network 10 (PLMN). Next, the requesting individual 30 sends a request to mobile network 10 for the subscriber of device 20's location, block 63.

Next, mobile network 10 determines whether the requesting individual is in the location's service profile of subscriber of device 20, block 65. If not, block 65 transfers control to block 67 via the no path. Block 67 indicates that the request is denied and sends an error message to the requesting individual, block 67.

Next if the requester is in the location service profile, mobile network 10 pages the subscriber's mobile device 20 for the required location information, block 69. Device 20 then determines its position using such systems as Global Positioning System 40 or multilateration methodology using base stations 50-52 or any other method for location determination. After device 20 determines its location information, network 10 received the subscriber's location information, block 71.

Then, mobile network 10 provides the subscriber's location information to the requesting individual 30. The location may be displayed upon the individual's cell phone display, or personal computer display screen. The location information may be displayed as a mark overlayed on a map, block 73.

Optionally the subscriber of mobile device 20 is notified that the location information request has been provided to requesting individual 30 and the identity of the individual 30 who has requested the information, block 75. Then the processes for location services is ended.

Optionally the subscriber of mobile device 20 can temporarily block location reporting without disturbing the list of authorized requesters by making a temporary suspension request to the service profile. The suspension is preferred to be user account and password protected to ensure against unintentional or malicious service blockage.

The location services described herein provides a subscriber with the ability to configure a list of individuals that have permission to obtain and view his or her location. The location of the subscriber may be objectively obtained without disturbing the subscriber for an active response. Further, the location of the subscriber may be obtained in real time and periodically updated to show movement of the subscriber. The subscriber's device may be something other than the traditional pager or mobile phone. For example, it may be a chip in a dog's collar or reside on a key chain or bracelet for a child or person having disabilities. The location services feature as another integrated feature to 2.5 G or greater wireless network thereby providing substantial cost savings to the subscriber.

Although the preferred embodiment of the invention has been illustrated, and that form described in detail, it will be readily apparent to those skilled in the art that various modifications may be made therein without departing from the spirit of the present invention or from the scope of the appended claims.

1. A method for providing location service for a mobile device, the method comprising the steps of:
configuring in a network a location service profile including at least one individual authorized to request the location service of the mobile device;
determining location information of the mobile device by the mobile device; and
sending by the network the location information to the at least one individual.

2. The method for providing a mobile device location service as claimed in claim 1, wherein there is further included a step of coupling the mobile device to a mobile user.

3. The method for providing a mobile device location service as claimed in claim 2, wherein there is further included a step of sending by the at least one individual a request to the network for the location information of the mobile device.

4. The method for providing a mobile device location service as claimed in claim 2, wherein there is further included a step of determining by the network whether the at least one individual is in the location service profile of the mobile device.

5. The method for providing a mobile device location service as claimed in claim 4, wherein if the at least one individual is in the location service profile, then there is further included a step of paging the mobile device by the network for the location information.

6. The method for providing a mobile device location service as claimed in claim 4, wherein if the at least one individual is not in the location service profile, then there is further included a step of sending by the network an error message to the at least one individual.

7. The method for providing a mobile device location service as claimed in claim 1, wherein the step of determining includes the step of using a Global Positioning System to determine the location information.

8. The method for providing a mobile device location service as claimed in claim 1, wherein there is further included a step of using by the mobile device a multilateration technique to determine the location information.

9. The method for providing a mobile device location service as claimed in claim 5, wherein there is further included a step of sending the location information by the mobile device to the network.

10. The-method for providing a mobile device location service as claimed in claim 9, wherein there is further included a step of sending by the network the location information to the at least one individual.

11. The method for providing a mobile device location service as claimed in claim 10, wherein there is further included a step of notifying by the network the mobile device that the location information has been sent to the at least one individual.

12. The method for providing a mobile device location service as claimed in claim 1, wherein there is further included a step of overlaying by the at least one individual the location information on a visual display.

13. A method for location service of a mobile user carrying a mobile device, the method comprising step of:
requesting location information of the mobile user by a requester;
determining by a mobile network whether the requester is authorized to receive the location information of the mobile user;
determining by the mobile device its location information; and
sending by the mobile network the location information to the requester.

14. The method for location service as claimed in claim 13, wherein there is further included a step of configuring by the mobile user a location service profile in the mobile network to include the requester as being authorized to receive the location information.

15. The method for location service as claimed in claim 14, wherein there is further included a step of designating by mobile user the mobile user as a valid requester.

16. The method for location service as claimed in claim 14 wherein there is further included a step of temporarily suspending by the mobile user the location service.

17. The method for location service as claimed in claim 14, wherein there is further included steps of:
comparing an identity of the requester with the identity of the location service profile to determine whether the requester is authorized to receive the location information; and
if the requester is not authorized to receive the location information, sending an error message to the requester by the mobile network.

18. The method for location service as claimed in claim 17, wherein if the requester is authorized to receive the location information, there is further included a step of paging the mobile device for the location information.

19. The method for location service as claimed in claim 18, wherein the step of determining by the mobile device includes the step of determining the location information of the mobile user by using a global positioning system.

20. The method for location service as claimed in claim 18, wherein the step of determining by the mobile device includes the step of determining the location information of the mobile user by performing a multilateration operation by the mobile device.

21. The method for location service as claimed in claim 18, wherein there is further included a step of sending the location information by the mobile network to the requester.

22. The method for location service as claimed in claim 21; wherein there is further included a step of notifying by the mobile network the mobile user that the requester has received the location information.
